(19) United States
(12) Patent Application Publication
(10) Pub. No.: US 2021/0273461 A1
(43) Pub. Date: Sep. 2, 2021

(54) CHARGING BALANCE DEVICE, SYSTEM AND METHOD FOR MULTICELL BATTERY PACK

(71) Applicant: TEAM YOUNG TECHNOLOGY CO., LTD., Taoyuan City (TW)

(72) Inventors: Tz-Min Lin, Taoyuan City (TW); Dy-Cheng Wang, Taoyuan City (TW)

(73) Assignee: TEAM YOUNG TECHNOLOGY CO., LTD., Taoyuan City (TW)

(21) Appl. No.: 16/902,263

(22) Filed: Jun. 16, 2020

(30) Foreign Application Priority Data
Feb. 27, 2020 (TW) 109106621

(51) Int. Cl. H02J 7/00

(52) U.S. Cl. CPC H02J 7/0016; H02J 7/007182; H02J 7/00714

(57) ABSTRACT

The invention discloses a charging balance device, system and method for multicell battery pack which can enable N batteries to maintain N−X batteries in a charging circuit during a system operation. The method includes sequentially performing: a constant current charging mode step: implementing a constant current charging mode for charging by a constant current, wherein the switching condition is that a storage capacity of X batteries having a highest storage capacity among the N−X batteries is greater than a storage capacity of the X offline batteries; and after a preset upper limit voltage value is met, changing to a constant voltage charging mode step: implementing a constant voltage charging mode for charging by a constant voltage, wherein the switching condition is that a voltage of X batteries having a highest voltage among the N−X batteries is greater than a voltage of the X offline batteries.

### CROSS-REFERENCE TO RELATED APPLICATION

This application claims the priority benefit of Taiwan application no. 109106621, filed on Feb. 27, 2020. The entirety of the above-mentioned patent application is hereby incorporated by reference herein and made a part of this specification.

### TECHNICAL FIELD

The invention relates to a multicell battery pack charging, and more particularly, to a charging balance device, system and method for multicell battery pack.

### BACKGROUND

Batteries are widely used in various electronic products, and usually adopt a multicell battery structure, that is, multiple batteries connected in series or parallel to supply the power required for the operation of electronic products. A multicell battery pack consisting of multiple batteries connected in series is often used in applications such as notebook computers, power tools without power cords, electric vehicles, and uninterruptible power supplies. An important function of a battery management circuit used in this type of multicell battery pack is to manage the balance of the battery pack. Battery balancing is the process of matching and controlling the voltage at two ends of each battery in the multicell battery pack during the use of the battery pack, which directly affects the effective use storage capacity and run time of the entire multicell battery pack. An imbalance battery will cause premature charge termination or early discharge termination and affect use performance of the battery.

In fact, internal resistances and storage capacities of the batteries of the same kind are slightly different. This difference will gradually increase as the number of charging/discharging cycles increases. The battery may be imbalance due to many factors, such as storage capacity mismatch between batteries, differences in charging state, changes in battery impedance, temperature gradients, and battery self-heating at high discharge rates. Although the multicell battery pack has good performance and high safety, it is still needed to prevent the battery from overcharge, overdischarge or overheating. In order to extend the life of the multicell battery pack and protect the safety of the user, a battery management system must be constructed to ensure that the battery operates within a safe range. Basically, a main function of the battery management system is to measure the voltage of the battery for adjustment and protection. In the multicell battery pack, due to the difference in internal resistances or manufacturing processes, a battery voltage inconsistency is likely to occur during use. Such a problem will cause the multicell battery pack to overcharge or overdischarge prematurely, which greatly affects the use efficiency and life of the multicell battery pack. The multicell battery pack will cause differences in battery storage capacity due to the difference in battery manufacturing or use. In the early days, traditional charging technologies were mainly based on a passive balancing method. The passive balancing method mainly achieves the effect of balancing batteries with different storage capacities by consuming battery energy for a long time, bypassing the shunt energy by converting the energy into heat through a bypass power resistor and a switch. Although this method is simple and low-cost, the circuit will waste too much energy as heat, and has the disadvantages of low efficiency and long balance time. However, when a charging current is too large and a balancing current is not enough, it will cause almost no balancing effect, and the batteries will still be imbalance. Consequently, a battery with a larger real storage capacity cannot be fully charged, causing a battery that is nearly fully charged to easily reach a cut-off voltage. However, because of the influence of the internal resistance of the battery, this cut-off voltage is quite different from an open circuit voltage of the battery. Therefore, it results in an early ending of charging, and thus the multicell battery pack cannot be fully charged.

### SUMMARY

In view of the above deficiencies, the invention aims to provide a charging balance device, a system and a method for multicell battery pack, which can effectively balance batteries with different storage capacities and maintain a fast charging when charging the multicell battery pack. At the same time, each battery in the multicell battery pack can achieve the effect of near full charged. The invention adopts an alternating rest structure, and such a structure can enable one of the batteries to be offline to maintain a stable charging of the whole multicell battery pack. When a battery in a charging circuit is switched to be a new offline battery and the original offline battery is added to the charging circuit, a controller can turn off a series switch connected to a switching circuit of the new offline battery, and turn on a bypass switch. In this way, the new offline battery will not be charged. Also, as a series switch connected to a switching circuit of the original offline battery is turned on and a bypass switch is turned off, the original offline battery may be added to the charging circuit for charging.

At the beginning of charging, a charging mode of the multicell battery pack is a constant current charging mode (in the following description, the constant current charging mode will be referred to as the CC mode). At this time, because a charging current is constant and can be a highest charging current, the multicell battery pack may have greater storage capacity and faster charging speed. In this CC mode, the invention enables the battery with a highest storage capacity to be offline first and adds the original offline battery. Accordingly, the storage capacity of each battery may be quickly charged, and the storage capacity of each battery may be balanced due to the alternating rest structure.

When the storage capacity of each battery of the multicell battery pack in the CC mode is almost full (i.e., after a preset upper limit voltage value is met), the charging mode of the multicell battery pack will be changed to a constant voltage charging mode (in the following description, the constant voltage charging mode will be referred to as the CV mode). At this time, because the voltage is constant and the charging current drops, the charging speed becomes slower. In this CV mode, the invention enables the battery with a highest voltage to be offline and adds the original offline battery, so that the multicell battery pack can maintain charging with a larger current in the constant voltage charging mode. In addition, by using a relative highest voltage value as a switching condition for battery alternation, it can ensure that the voltage of each battery will converge to be close to the same value. Because when the relative highest voltage value is reached, the voltage of one specific battery in the charging circuit will be replaced, offline and stopped from being charged, and the battery with a relatively lower voltage value that was originally offline is added to the charging circuit. In this CV mode, by continuously replacing the battery with the highest voltage, all batteries will converge to be close to the same voltage value. Therefore, the charging balance device, system and method thereof in the invention can enable each battery in the multicell battery pack to reach an optimum balance condition having all batteries being close to be fully charged.

To achieve the above purpose, the invention provides a charging balance device for multicell battery pack, which is adapted to a charging system having N batteries where N is a positive integer, and comprises: a plurality of switching circuits, configured to enable N−X batteries among the N batteries to form a charging circuit where X is a positive integer, and enable remaining X batteries to be disconnected from the charging circuit and served as offline batteries; and a controller, configured to detect an electric property of each of the batteries, sequentially perform a constant current charging mode and a constant voltage charging mode, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation, wherein a constant current is used for charging in the constant current charging mode, and the switching condition is that a storage capacity of X batteries having a highest storage capacity among the N−X batteries is greater than a storage capacity of the X offline batteries, wherein a constant voltage is used for charging in the constant voltage charging mode, and wherein the switching condition is that a voltage of X batteries having a highest voltage among the N−X batteries is greater than a voltage of the X offline batteries.

Further, to achieve the above purpose, in the charging balance device for multicell battery pack disclosed by the invention, the switching circuits comprise M switching circuits, M is a positive integer equal to N, the M switching circuits are connected to the N batteries one-to-one, and the controller is connected to the M switching circuits and controls the M switching circuits to form the charging circuit.

Further, to achieve the above purpose, in the charging balance device for multicell battery pack disclosed by the invention, each of the switching circuits includes a series switch and a bypass switch, the series switch is connected to the battery in series, and the bypass switch is connected to the series switch and the battery and form a parallel connection with the series switch and the battery.

Further, to achieve the above purpose, in the charging balance device for multicell battery pack disclosed by the invention, a condition for changing the constant current charging mode to the constant voltage charging mode is to meet a preset upper limit voltage value.

Further, to achieve the above purpose, in the charging balance device for multicell battery pack disclosed by the invention, the controller is a microcontroller unit (MCU), a personal computer (PC), a programmable logic controller (PLC) or a field-programmable gate array (FPGA).

To achieve the above purpose, the invention provides a charging balance system for multicell battery pack, which comprises: N batteries, wherein N is a positive integer; a plurality of switching circuits, configured to enable N−X batteries among the N batteries to form a charging circuit where X is a positive integer, and enable remaining X batteries to be disconnected from the charging circuit and served as offline batteries; and a controller, configured to detect an electric property of each of the batteries, sequentially perform a constant current charging mode and a constant voltage charging mode, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation, wherein a constant current is used for charging in the constant current charging mode, and the switching condition is that a storage capacity of X batteries having a highest storage capacity among the N−X batteries is greater than a storage capacity of the X offline batteries, wherein a constant voltage is used for charging in the constant voltage charging mode, and wherein the switching condition is that a voltage of X batteries having a highest voltage among the N−X batteries is greater than a voltage of the X offline batteries.

Further, to achieve the above purpose, in the charging balance system for multicell battery pack disclosed by the invention, the switching circuits include M switching circuits, M is a positive integer equal to N, the M switching circuits are connected to the N batteries one-to-one, and the controller is connected to the M switching circuits and controls the M switching circuits to form the charging circuit.

Further, to achieve the above purpose, in the charging balance system for multicell battery pack disclosed by the invention, each of the switching circuits comprises a series switch and a bypass switch, the series switch is connected to the battery in series, and the bypass switch is connected to the series switch and the battery and form a parallel connection with the series switch and the battery.

Further, to achieve the above purpose, in the charging balance system for multicell battery pack disclosed by the invention, a condition for changing the constant current charging mode to the constant voltage charging mode is to meet a preset upper limit voltage value.

Further, to achieve the above purpose, in the charging balance system for multicell battery pack disclosed by the invention, the controller is a microcontroller unit (MCU), a personal computer (PC), a programmable logic controller (PLC) or a field-programmable gate array (FPGA).

In addition, to achieve the above purpose, the invention provides a charging balance method for multicell battery pack, which is adapted to a charging system having N batteries where N is a positive integer. The charging system comprises a plurality of switching circuits, configured to enable N−X batteries among the N batteries to form a charging circuit where X is a positive integer, and enable remaining X batteries to be disconnected from the charging circuit and served as offline batteries; and a controller, configured to detect an electric property of each of the batteries, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation. The method comprises sequentially performing the following steps:

a constant current charging mode step: implementing a constant current charging mode for charging by a constant current, wherein the switching condition is that a storage capacity of X batteries having a highest storage capacity among the N−X batteries is greater than a storage capacity of the X offline batteries; and

a constant voltage charging mode step: implementing a constant voltage charging mode for charging by a constant voltage, wherein the switching condition is that a voltage of X batteries having a highest voltage among the N−X batteries is greater than a voltage of the X offline batteries.

Further, to achieve the above purpose, in the charging balance method for multicell battery pack disclosed by the invention, a condition for changing the constant current charging mode to the constant voltage charging mode is to meet a preset upper limit voltage value.

Further, to achieve the above purpose, in the charging balance method for multicell battery pack disclosed by the invention, the controller is a microcontroller unit (MCU), a personal computer (PC), a programmable logic controller (PLC) or a field-programmable gate array (FPGA).

To make the aforementioned and other purposes, features and advantages of the invention more comprehensible, various embodiments accompanied with drawings are described in detail as follows. However, it should be understood by those skilled in the art that, the detailed description and the specific embodiments provided for implementing the invention are simply used to describe the invention rather than limit the scope defined by claims of the invention.

### BRIEF DESCRIPTION OF THE DRAWINGS

FIG. 1 shows a block diagram of a charging balance system for multicell battery pack according to the invention.

FIG. 2 shows a comparison diagram of battery charging capacities according to a traditional charging technology and a charging balance method for multicell battery pack of the invention.

FIG. 3 shows a flowchart of steps in the charging balance method for multicell battery pack according to the invention.

### DETAILED DESCRIPTION

Components and achievable effects of the charging balance device, the system and the method for multicell battery pack of the invention will be described in the corresponding preferred embodiments below with reference to the drawings. Nonetheless, components, size and appearance of the charging balance device, the system and the method for multicell battery pack in the drawings are merely used to describe technical features of the invention rather than limit the invention.

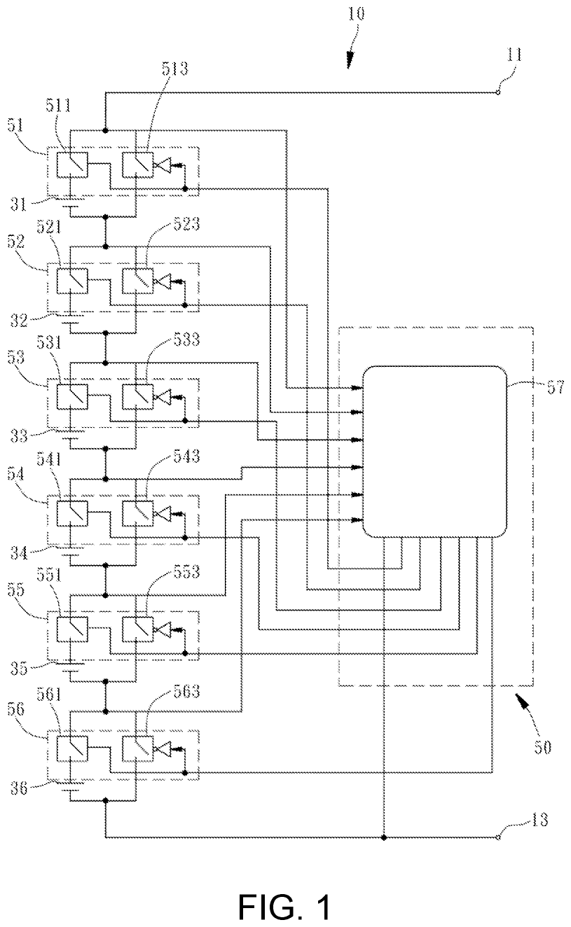

FIG. 1 is a block diagram of a charging balance system for multicell battery pack of the invention. The charging balance system for multicell battery pack of the invention is adapted to a power system. The power system may be a device that needs to be operated by battery power, such as a portable computer, a mobile phone, an electric vehicle, an electric locomotive or a portable small home appliance.

As shown in FIG. 1, a charging balance system for multicell battery pack 10 is connected to the said power system by two ends 11 and 13, and comprises six batteries 31 to 36 and a charging balance device for multicell battery pack 50. The charging balance device for multicell battery pack 50 selects 5 batteries 31 to 35 from the six batteries 31 to 36 to form a charging circuit, and detects an electric property of each of the six batteries 31 to 36, respectively. Among them, the battery 36 not assigned to be in the charging circuit is defined as an offline battery. When the result of comparing the electric property of each of the five batteries 31 to 35 with the electric property of the offline battery 36 meets a switching condition, the charging balance device for multicell battery pack 50 selects one of the five batteries 31 to 35 to be disconnected from the charging circuit, and adds the offline battery 36 to the charging circuit. Here, the disconnected battery becomes a new offline battery.

Continuing to refer to FIG. 1, the charging balance device for multicell battery pack 50 comprises six switching circuits 51 to 56 and a controller 57. The number of the switching circuits 51 to 56 is equal to the number of batteries, that is, N and M defined in claims represent the value 6. The six switching circuits 51 to 56 are connected to the six batteries 31 to 36 one-to-one. The controller 57 is connected to the six switching circuits 51 to 56, and controls the six switching circuits 51 to 56 to form the charging circuit. In other words, the controller 57 has multiple ports to connect the six switching circuits 51 to 56. The controller 57 having multiple ports is understandable to persons skilled in the art and thus description regarding the same will not be repeated here.

Each of the switching circuits 51 to 56 comprises a series switch (511 to 561) and a bypass switch (513 to 563). The series switch (511 to 561) is connected to the battery (31 to 36) in series, and the bypass switch (513 to 563) is connected to the series switch (511 to 561) and the battery (31 to 36) and form a parallel connection with the series switch (511 to 561) and the battery (31 to 36). Among them, since each of N and M represents a specific value, persons skilled in the art can easily understand that the value is variable. The series switch and the bypass switch of the switching circuit may be transistors, diodes or a circuit composed by these active components.

The charging circuit is formed by the controller 57 controlling the switching circuits 51 to 56. For instance, initially, the batteries 31 to 35 are selected to form the charging circuit and the battery 36 is served as the offline battery. This means that, the series switches connected to the switching circuits of the batteries 31 to 35 are turned on, whereas the bypass switches are turned off. Yet, the battery 36 is at rest, and the series switch connected to the switching circuit of the battery 36 is turned off, whereas the bypass switch is turned on. Next, when detecting the electric property of each of the batteries 31 to 35 in the charging circuit and the electric property of the offline battery 36 and comparing the electric property of each of the batteries 31 to 35 with the electric property of the offline battery 36, respectively, the controller 57 may find out that the electric property of the battery 35 meets the switching condition. Therefore, the controller 57 controls the operation of the switches connected to the battery 35 to enable the battery 35 to become the new offline battery so the battery 35 can rest temporarily. Meanwhile, the battery 36 (the original offline battery) is added to the charging circuit. It should be noted that a total voltage of all the batteries disposed in the traditional power system is equal to the voltage required by the power system. That is to say, there will be no additional offline (idle) battery. However, in addition to the corresponding batteries disposed according to the power required by the power system, one additional battery is added in the invention. Accordingly, in this embodiment, N is 6, the charging circuit is formed by N−1 (equal to 5) batteries, and the offline battery may rest and wait to be assigned for charging.

The operation and determination logic of the charging balance device for multicell battery pack 50 and the charging balance system for multicell battery pack 10 of the invention are to gradually increase the storage capacities of the batteries 31 to 36. Therefore, at the beginning of charging (assuming that the batteries 31 to 36 are all in a low storage capacity state, but not limited to this state), a charging mode for multicell battery pack is the constant current charging mode (the CC mode) for charging. At this time, because the charging current is a constant and higher charging current, the multicell battery pack may have greater storage capacity and faster charging speed. In this CC mode, the invention will enable the battery with the highest storage capacity to be offline first and add the original offline battery, so that the storage capacity of each battery may be quickly increased and the storage capacity of each battery may tend to be balance. For example, normally, a lithium ion battery in a multicell battery pack may be charged by a constant current to reach a preset upper limit charging voltage value in the constant current mode (the CC mode). Here, the preset upper limit charging voltage value is usually 4.1V/battery or 4.2V/battery. In this embodiment, initially, the batteries 31 to 35 are selected to form the charging circuit and the battery 36 is served as the offline battery. This means that, the series switches connected to the switching circuits of the batteries 31 to 35 are turned on, whereas the bypass switches are turned off. Yet, the battery 36 is at rest, and the series switch connected to the switching circuit of the battery 36 is turned off, whereas the bypass switch is turned on. Next, when detecting the storage capacity of each of the batteries 31 to 35 in the charging circuit and the storage capacity of the offline battery 36 and comparing the storage capacity of each of the batteries 31 to 35 with the storage capacity of the offline battery 36, respectively, the controller 57 may find out that the battery 35 has the highest storage capacity that is greater than the storage capacity of the offline battery 36. Accordingly, the controller 57 determines that the result meets the switching condition of the constant current charging mode (the CC mode). Therefore, the controller 57 controls the operation of switches connected to the battery 35 to enable the battery 35 to become the new offline battery so the battery 35 can rest temporarily. Meanwhile, the battery 36 (the original offline battery) is added to the charging circuit.

When the storage capacity of the batteries 31 to 36 are almost full to be close to the upper limit charging voltage value, the charging mode for multicell battery pack will be changed to the constant voltage charging mode (the CV mode) for charging. At this time, because the voltage is constant and the charging current drops, the charging speed becomes slower. In this CV mode, the invention enables the battery with a relative highest voltage to be offline, so that the multicell battery pack may be charged by a greater current in this constant voltage charging mode (the CV mode) by satisfying the following formula (1):

I_{charge}=(V_{CV}−V_{totalcells})/R_{charge}

wherein I_{charge} is the charging current, V_{CV} is the charging voltage in the constant voltage charging mode (the CV mode), V_{totalcells} is a total voltage of the multicell battery pack, and R_{charge} is a resistance of an overall charging path. From the formula (1), it can be known that when the charging mode enters the constant voltage charging mode (the CV mode), with R_{charge} and V_{CV} remaining unchanged, the charging current can be increased only by reducing the value of V_{totalcells}. Therefore, in the constant voltage charging mode (the CV mode), the invention will enable the battery with the highest voltage to be offline and add the original offline battery to the charging circuit (the original offline battery voltage lower than the new offline battery voltage is equivalent to reduction on V_{totalcells}) so as to increase the charging current and the charging speed. In addition, by using a relative highest voltage value as the switching condition for battery alternation, it can ensure that the charging voltage of each battery will converge to be close to the same value. That is, when having the voltage increased to the relative highest voltage value, the battery will be replaced, offline and stopped from being charged. Therefore, by constantly replacing the battery with the highest voltage and adding the battery with a relatively lower voltage value that was originally offline to the charging circuit, all the battery voltages will converge to be close to the same value. Making the battery with the highest voltage to be offline can ensure that the voltage of each battery is close to the same, and can ensure that each battery can be fully charged to be close to a fully charged voltage at the same time in the constant voltage charging mode (the CV mode). For example, the fully charged voltage of the lithium ion battery is 4.2V. When one of the batteries reaches 4.2V, the multicell battery pack will stop charging. However, since the invention will make all battery voltages to be close to 4.2V, all the batteries will be very close to a fully charged state. In this embodiment, it is assumed that the batteries 31 to 35 are used in the charging circuit in the constant voltage charging mode (CV mode), and the battery 36 is served as the offline battery. This means that, the series switches connected to the switching circuits of the batteries 31 to 35 are turned on, whereas the bypass switches are turned off. Yet, the battery 36 is at rest, and the series switch connected to the switching circuit of the battery 36 is turned off, whereas the bypass switch is turned on. Next, the controller 57 detects the voltage of each of the batteries 31 to 35 in the charging circuit and the voltage of the offline battery 36 and compares the voltage of each of the batteries 31 to 35 with the voltage of the offline battery 36, respectively. Then, when comparing the voltage of each of the batteries 31 to 35 with the voltage of the offline battery 36, it is found that the battery 35 has the highest voltage greater than the voltage of the offline battery 36. Therefore, the controller 57 determines that the result meets the switching condition of the constant voltage charging mode (the CV mode). Therefore, the controller 57 controls the operation of switches connected to the battery 35 to enable the battery 35 to become the new offline battery so the battery 35 can rest temporarily. Meanwhile, the battery 36 (the original offline battery) is added to the charging circuit.

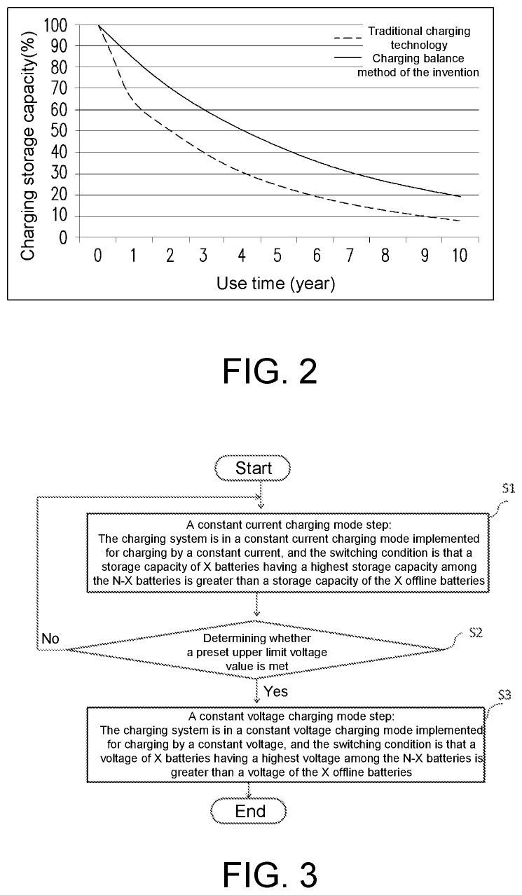

Referring to FIG. 2, FIG. 2 shows a comparison diagram of battery charging storage capacities according to a traditional charging technology and a charging balance method for multicell battery pack of the invention. FIG. 2 is a simulation of a charging effect of a multicell battery pack with four batteries connected in series, in which it is assumed that there are 300 charging/discharging cycles per year. With the increase in the use time of traditional charging technology, the batteries will quickly age, and a total charging storage capacity will gradually decrease with use time. However, by using the charging balance method for multicell battery pack of the invention, the total charging storage capacity is higher as compared to the traditional charging technology and each battery can be stably charged to the fully charged state close to balance. This shows that the charging balance method for multicell battery pack of the invention can achieve the effect of greatly improving the use efficiency and life of the multicell battery pack by balancing the difference between the storage capacities of the batteries so that all the batteries can be fully charged to be close to the full voltage at the same time.

Referring to FIG. 1 and FIG. 3 together with the description of the charging balance system for multicell battery pack 10 and the charging balance device for multicell battery pack 50 described above, FIG. 3 is a flowchart of steps in the charging balance method for multicell battery pack according to an embodiment of the invention. In this embodiment, N is 6, the charging circuit is formed by N−1 (equal to 5) batteries, and the offline battery may rest and wait to be assigned for charging. The charging balance method for multicell battery pack of the invention is adapted to a charging system 10 having N batteries 31 to 36 where N is a positive integer. The charging system 10 comprises a plurality of switching circuits 51 to 56, which are configured to enable N−1 batteries among the N batteries 31 to 36 to form a charging circuit, and enable remaining one battery to be disconnected from the charging circuit and served as offline batteries; and a controller 57, configured to detect an electric property of each of the batteries 31 to 36, compare the each of the N−1 batteries with said one offline battery, respectively, enable one battery that meets a switching condition to be disconnected from the charging circuit and served as new offline batteries, and add said one offline battery to the charging circuit, so as to enable the N batteries 31 to 36 to maintain the N−1 batteries in the charging circuit during a system operation. The charging balance method for multicell battery pack of the invention sequentially performs the following steps. First, in step S1, which is also known as the constant current charging mode step, a constant current charging mode (the CC mode) is implemented for charging by a constant current, and the switching condition is that a storage capacity of one battery having a highest storage capacity among the N−1 batteries is greater than a storage capacity of said one offline battery. The charging current is constant and may be the highest charging current. Therefore, the storage capacity for charging the multicell battery pack is greater and the charging speed is faster. At this time, by enabling the battery with the highest “storage capacity” to be offline first and adding the original offline battery, the storage capacity of each of the batteries can be fully charged quickly, and the storage capacity of each of the batteries will be charged to be almost balance. In step S2, whether a preset upper limit voltage value is met is determined. In one embodiment, when the storage capacity of each of the batteries of the multicell battery pack in the CC mode is almost full (i.e., after a preset upper limit voltage value is met), the charging mode of the multicell battery pack will be changed to the constant voltage charging mode (the CV mode). If the preset upper limit voltage value is met, step S3 is executed; otherwise, step S1 (the constant current charging mode step) is executed again continuously; and In step S3, which is also known as the constant voltage charging mode, when the storage capacity of the battery is almost full, the constant voltage charging mode (the CV mode) is implemented for charging by a constant voltage, and the switching condition is that a voltage of one battery having a highest voltage among the N−1 batteries is greater than a voltage of said one offline battery. At this time, because the voltage is constant and the charging current drops, the charging speed becomes slower. By enabling the battery with the highest “voltage” to be offline and adding the original offline battery for increasing the charging current and the charging speed, the multicell battery pack can conduct charging with a larger current in the constant voltage charging mode. Accordingly, by constantly replacing the battery with the relative highest voltage, the voltage of all the batteries in the multicell battery pack will converge to be the same value, so as to achieve the effect that each battery will be fully charged.

Although the number of the offline batteries in this embodiment is one, in practice, the number of offline batteries may also be two or more. When the offline battery is designed to be two or more, persons skilled the art can still understand that the total number of batteries will increase through the description of the invention. That is to say, the number of batteries in the electrical circuit could be N−2 or N−X, where X indicates that there are more than two offline batteries.

In summary, when charging the multicell battery pack, in addition to effectively enable at least one battery to be offline and waiting to be assigned for charging, the charging balance system for multicell battery pack disclosed by the invention may further control each of the batteries to be stably charged, so as to balance the storage capacity of each battery.

Finally, it is to be understood that the constituent elements disclosed in foregoing embodiments of the invention are merely examples rather than limitations to the scope of the invention. Other replacements or modifications of the equivalent element should be covered by the scope defined by claims of the invention.

1. A charging balance device for multicell battery pack, adapted to a charging system having N batteries where N is a positive integer, and comprising:
a plurality of switching circuits, configured to enable N−X batteries among the N batteries to form a charging circuit where X is a positive integer, and enable remaining X batteries to be disconnected from the charging circuit and served as offline batteries; and
a controller, configured to detect an electric property of each of the batteries, sequentially perform a constant current charging mode and a constant voltage charging mode, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation,
wherein a constant current is used for charging in the constant current charging mode, and the switching condition is that a storage capacity of X batteries having a highest storage capacity among the N−X batteries is greater than a storage capacity of the X offline batteries, wherein a constant voltage is used for charging in the constant voltage charging mode, and the switching condition is that a voltage of X batteries having a highest voltage among the N−X batteries is greater than a voltage of the X offline batteries.

2. The charging balance device for multicell battery pack of claim 1, wherein the switching circuits comprise M switching circuits, M is a positive integer equal to N, the M switching circuits are connected to the N batteries one-to-one, and the controller is connected to the M switching circuits and controls the M switching circuits to form the charging circuit.

3. The charging balance device for multicell battery pack of claim 2, wherein each of the switching circuits comprises a series switch and a bypass switch, the series switch is connected to the battery in series, and the bypass switch is connected to the series switch and the battery and form a parallel connection with the series switch and the battery.

4. The charging balance device for multicell battery pack of claim 1, wherein a condition for changing the constant current charging mode to the constant voltage charging mode is to meet a preset upper limit voltage value.

5. A charging balance system for multicell battery pack, comprising:
N batteries, wherein N is a positive integer;
a plurality of switching circuits, configured to enable N−X batteries among the N batteries to form a charging circuit where X is a positive integer, and enable remaining X batteries to be disconnected from the charging circuit and served as offline batteries; and
a controller, configured to detect an electric property of each of the batteries, sequentially perform a constant current charging mode and a constant voltage charging mode, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation,
wherein a constant current is used for charging in the constant current charging mode, and the switching condition is that a storage capacity of X batteries having a highest storage capacity among the N−X batteries is greater than a storage capacity of the X offline batteries, wherein a constant voltage is used for charging in the constant voltage charging mode, and the switching condition is that a voltage of X batteries having a highest voltage among the N−X batteries is greater than a voltage of the X offline batteries.

6. The charging balance system for multicell battery pack of claim 5, wherein the switching circuits comprise M switching circuits, M is a positive integer equal to N, the M switching circuits are connected to the N batteries one-to-one, and the controller is connected to the M switching circuits and controls the M switching circuits to form the charging circuit.

7. The charging balance system for multicell battery pack of claim 6, wherein each of the switching circuits comprises a series switch and a bypass switch, the series switch is connected to the battery in series, and the bypass switch is connected to the series switch and the battery and form a parallel connection with the series switch and the battery.

8. The charging balance system for multicell battery pack of claim 5, wherein a condition for changing the constant current charging mode to the constant voltage charging mode is to meet a preset upper limit voltage value.

9. A charging balance method for multicell battery pack, adapted to a charging system having N batteries where N is a positive integer, the charging system comprising: a plurality of switching circuits, configured to enable N−X batteries among the N batteries to form a charging circuit where X is a positive integer, and enable remaining X batteries to be disconnected from the charging circuit and served as offline batteries; and a controller, configured to detect an electric property of each of the batteries, compare the electric property of each of the N−X batteries with the electric property of each of the X offline batteries, respectively, enable X batteries that meet a switching condition to be disconnected from the charging circuit and served as new offline batteries, and add the X offline batteries to the charging circuit, so as to enable the N batteries to maintain the N−X batteries in the charging circuit during a system operation, wherein the method comprises sequentially performing the following steps:
a constant current charging mode step: implementing a constant current charging mode for charging by a constant current, wherein the switching condition is that a storage capacity of X batteries having a highest storage capacity among the N−X batteries is greater than a storage capacity of the X offline batteries; and
a constant voltage charging mode step: implementing a constant voltage charging mode for charging by a constant voltage, wherein the switching condition is that a voltage of X batteries having a highest voltage among the N−X batteries is greater than a voltage of the X offline batteries.

10. The charging balance method for multicell battery pack of claim 9, wherein a condition for changing the constant current charging mode to the constant voltage charging mode is to meet a preset upper limit voltage value.
